(19) United States
(12) Patent Application Publication
(10) Pub. No.: US 2014/0128492 A1
(43) Pub. Date: May 8, 2014

(54) Polyurethanes Obtained From Hydroxyalkanoate Crosslinking Agents

(71) Applicant: Robert S. Whitehouse, Cambridge, MA (US)

(72) Inventor: Robert S. Whitehouse, Cambridge, MA (US)

(21) Appl. No.: 14/110,880

(22) PCT Filed: Apr. 20, 2012
(86) PCT No.: PCT/US12/34350

§ 371 Date: Jan. 21, 2014

Related U.S. Application Data
(60) Provisional application No. 61/480,871, filed on Apr. 29, 2011.
(60) Provisional application No. 61/535,390, filed on Sep. 16, 2011.

(51) Int. Cl. C08G 18/83; C08J 9/12

(52) U.S. Cl. CPC C08G 18/833; C08J 9/12
USPC 521/170; 525/454

(57) ABSTRACT

The present invention relates to polyurethanes resulting from a reaction that includes a hydroxyalkanoate crosslinking agent. Methods of making polyurethanes are further described.

### BACKGROUND OF THE INVENTION

This application claims the benefit under 35 U.S.C. §119(e) of prior U.S. Provisional Patent Application No. 61/480,871, filed Apr. 29, 2011, and U.S. Provisional Patent Application No. 61/535,390, filed Sep. 16, 2011, which are incorporated in its entirety by reference herein.

The present invention relates to polyurethanes and products containing polyurethanes and to methods of making polyurethanes. More specifically, the present invention relates to polyurethanes obtained from reactants that include a crosslinking agent that is derived in part from at least a hydroxyalkanoate. Other aspects of the present invention are provided below.

In general, the raw materials for preparing polyurethanes are polyisocyanates, polyols, diamines, catalysts, additives, and blocking agents. The polyisocyanates are either aliphatic, like hexamethylene diisocyanates, isophorone diisocyanate, and 4,4′-diisocyanate dicyclo hexylmethane, or the polyisocyanates can be aromatic, like 2,4-toluene diisocyanate, 1,5-naphthalene diisocyanate, and 4,4′-methylene diphenyl diisocyanate. The polyols are typically polyethers, such as propylene glycol and trimethylolpropane combined with sucrose or polyesters, or ethylene glycol, 1,2-propanediol, 1,4-butenediol, and diethylene glycol combined with glycerol. Polyethers are typically used to produce flexible and rigid foams and polyesters are typically used to produce elastomers, flexible foams, and coatings. Lewis acids and Lewis bases are typically used as catalysts. Additives, which can be present, are typically polysiloxane-polyether, carbodiamide piperazine, chloro-fluoro-hydrocarbons, and phosphorous and nitrogen containing compounds.

Polyurethanes have been obtained from the reaction product of hydroxyalkanoate(s) and isocyanate(s) and, for instance, a polyol compound. As described in U.S. Pat. No. 6,753,384 B2 which is incorporated in its entirety by reference herein), polyurethanes have been obtained by the reaction of at least one product containing at least two isocyanate groups and at least one compound having at least two hydroxyl groups having different reactivity to the isocyanate groups. The compound having at least two hydroxyl groups, as described in the '384 patent, can be a thermally decomposable or biodegradable hydroxyalkanoate component. In the '384 patent, the hydroxyalkanoate component was used as the polyol compound, where the polyurethane is formed by reacting the isocyanate compound with the polyol compound. The hydroxyalkanoate was thus used in a large weight percent. As described in the '384 patent, the weight ratio of isocyanate to the hydroxyalkanoate compound was a weight ratio of from about 0.5:1 to about 2:1. The '384 patent described the presence of other conventional reactants including catalysts, blowing agents, flame retardants, foam stabilizers, fillers, antioxidants, pigments, and the like.

While the polyurethane formed in the '384 patent was a significant advancement in polyurethane chemistry, especially due to the use of a thermally decomposable or biodegradable hydroxyalkanoate component, the performance properties were about the same, but not better than, conventional polyurethane formed from a conventional polyol compound and isocyanate.

### SUMMARY OF THE PRESENT INVENTION

An objective of the present invention is to provide polyurethanes containing a compound derived from a hydroxyalkanoate, but which provides improved properties over conventional polyurethanes.

A further feature of the present invention is to provide polyurethanes that have equal or about equal load-bearing performance compared to conventional polyurethanes.

A further feature of the present invention is to provide polyurethanes having improved tear strength, elongation, tensile strength, and/or resiliency compared to conventional polyurethanes.

An additional feature of the present invention is to provide polyurethanes having improved durability as reflected by a dynamic fatigue test compared to conventional polyurethanes.

An additional feature of the present invention is to provide polyurethanes having a combination of one of more of the above-described properties or one or more properties described herein.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a polyurethane (e.g., foam) comprising the reaction product of:

(a) at least one isocyanate;

(b) at least one polyol; and

(c) at least one crosslinking agent that is a reaction product of:
i.) 3-hydroxyalkanoate, such as 3-hydroxyalkanoate ester or 3-hydroxyalkanoate (e.g., 3-hydroxyalkanoate, 3-hydroxyalkanoate oligomer, or 3-hydroxyalkanoate polymer) with
ii.) at least one amine having a single primary or secondary amine functionality and at least two hydroxyl groups having primary or secondary hydroxyl functionality.

The crosslinking agent is present in crosslinking amounts for purposes of forming the polyurethane. The crosslinking agent can be present in an amount of from one part per hundred of the polyol present to about 10 parts per hundred of the polyol present in the reaction.

The present invention further relates to products containing or formed from the polyurethanes of the present invention, such as foams, elastomers, adhesives, coatings, textiles, and the like.

The present invention further relates to methods of forming the polyurethane of the present invention which involves reacting:

(a) at least one isocyanate;

(b) at least one polyol; and

(c) at least one crosslinking agent that is a reaction product of:
i.) 3-hydroxyalkanoate, such as 3-hydroxyalkanoate ester or 3-hydroxyalkanoate (e.g., 3-hydroxyalkanoate, 3-hydroxyalkanoate oligomer, or 3-hydroxyalkanoate polymer) with
ii.) at least one amine having a single primary or secondary amine functionality and at least two hydroxyl groups having primary or secondary hydroxyl functionality.

The present invention further relates to polyurethanes having one or more of the physical properties described herein.

It is to be understood that both the foregoing general description and the following detailed description are exemplary and explanatory only and are intended to provide a further explanation of the present invention, as claimed.

### DETAILED DESCRIPTION OF THE PRESENT INVENTION

The present invention relates to polyurethanes and products made from or containing polyurethanes. The present invention also relates to methods of making polyurethanes. More specifically, the present invention involves the use of a crosslinking agent(s) that is the reaction product of at least one hydroxyalkanoate component with at least one amine. With the use of this type of crosslinking agent with the other reactants used to form a polyurethane, for instance, at least one isocyanate and at least one polyol, a polyurethane can be formed which has beneficial properties as described herein.

A polyurethane can be or include the reaction product of:

(a) at least one isocyanate;

(b) at least one polyol; and

(c) at least one crosslinking agent that is a reaction product of:
i.) at least one hydroxyalkanoate (e.g., 3-hydroxyalkanoate), such as at least one 3-hydroxyalkanoate ester and/or 3-hydroxyalkanoate (e.g., 3-hydroxyalkanoate, 3-hydroxyalkanoate oligomer or 3-hydroxyalkanoate polymer) with
ii.) at least one amine having a single primary or secondary amine functionality and at least two hydroxyl groups having primary or secondary hydroxyl functionality.

With regard to the at least one isocyanate, for purposes of the present invention, the at least one isocyanate can be or include an isocyanate-containing material. One or more isocyanates can be used in the reaction.

The isocyanate containing material can be a polyisocyanate. The isocyanate or isocyanate-containing material can contain at least two isocyanate groups per molecule. The polyisocyanates can be any polyisocyanate traditionally used in the formation of polyurethanes. These polyisocyanates can be modified or unmodified versions. Preferably, the polyisocyanate is an aromatic polyisocyanate. A more specific example would be a toluene diisocyanate or mixtures containing toluene diisocyanate. The isocyanates can also be modified by other components, such as urethane, allophanate, uretdione, or other groups. The isocyanates described earlier can also be used. The isocyanate component can be or include a toluene diisocyanate, methylene 4,4′ diphenyl diisocyanate, isophorone diisocyanate, hexamethylene diisocyanate, or combinations thereof. Generally, the amount of isocyanate used would be the same as in the conventional making of polyurethanes. Examples of amounts are from about 5 to about 50% by weight of total reactants.

In more detail, the isocyanate can be a polyisocyanate, such as a molecule with two or more isocyanate functional groups, R—(N═C═O)_{n≧2}. The polyol can be a molecule with two or more hydroxyl functional groups, R′—(OH)_{n≧2}. The reaction product is a polymer containing the urethane linkage, —RNHCOOR′—.

The isocyanate can be an aromatic, such as diphenylmethane diisocyanate (MDI) or toluene diisocyanate (TDI); or aliphatic, such as hexamethylene diisocyanate (HDI) or isophorone diisocyanate (IPDI). An example of a polymeric isocyanate is polymeric diphenylmethane diisocyanate, which is a blend of molecules with two-, three-, and four- or more isocyanate groups, with an average functionality of 2.7. Isocyanates can be further modified by partially reacting them with a polyol to form a prepolymer. A quasi-prepolymer is formed when the stoichiometric ratio of isocyanate to hydroxyl groups is greater than 2:1. A true prepolymer is formed when the stoichiometric ratio is equal to 2:1.

Other aromatic isocyanates include p-phenylene diisocyanate (PPDI), naphthalene diisocyanate (NDI), and o-tolidine diisocyanate (TODI). Examples of isocyanates include 1,6-hexamethylene diisocyanate (HDI), 1-isocyanato-3-isocyanatomethyl-3,5,5-trimethyl-cyclohexane (isophorone diisocyanate, IPDI), and 4,4′-diisocyanato dicyclohexylmethane (H₁₂MDI or hydrogenated MDI). Other aliphatic isocyanates include cyclohexane diisocyanate (CHDI), tetramethylxylene diisocyanate (TMXDI), and 1,3-bis(isocyanatomethyl)cyclohexane (H₆XDI).

Regarding the polyol, at least one polyol can be used as part of the reactants to form the polyurethane. One or more polyols can be used. The polyol can be a compound or material that contains two hydroxyl groups, also known as diols, or it can contain more than two hydroxyl groups, such as triols and the like. The polyol can be an oligomer or polymer. For instance, the polyol can have a low molecular weight, for instance, from 500 to 10,000 number average MW. The polyol can be a polyether polyol or a polyester polyol. Polyols are distinguished from short chain or low-molecular weight glycol chain extenders and cross linkers such as ethylene glycol (EG), 1,4-butanediol (BDO), diethylene glycol (DEG), glycerine, and trimethylolpropane (TMP). The polyols are polymers in their own right. They can be formed by base-catalyzed addition of propylene oxide (PO), ethylene oxide (EO) onto a hydroxyl or amine containing initiator, or by polyesterification of a di-acid, such as adipic acid, with glycols, such as ethylene glycol or dipropylene glycol (DPG).

The polyols can be classified according to their end use as flexible or rigid polyols, depending on the functionality of the initiator and their molecular weight. Taking into account functionality, flexible polyols have molecular weights from 2,000 to 10,000 (OH# from 18 to 56). Rigid polyols have molecular weights from 250 to 700 (OH# from 300 to 700). Polyols with molecular weights from 700 to 2,000 (OH# 60 to 280) are used to add stiffness or flexibility to base systems, as well as increase solubility of low molecular weight glycols in high molecular weight polyols.

An example is polyether polyols, polyester polyols, polycarbonate polyols, polycaprolactone polyols, polybutadiene polyols, polysulfide polyols, or combinations thereof. The polyol as a further example can be a polymer polyol or polymeric polyol. For instance, the polymer polyol can comprise a vinyl dispersion(s). The polyol can be or include SAN (styrene-acrylonitrile) copolymer type(s), PHD (polyuria particle dispersions), and/or PIPA (polyisocyanate polyadditions) type(s), or any combinations thereof. The polyol can be or include soybean oil polyol(s).

The amount of polyol present can be provided as a weight ratio compared to the isocyanate present. Specifically, the weight ratio of isocyanate to the polyol can be from about 0.5:1 to about 2:1 or other amounts.

With respect to the crosslinking agent, the crosslinking agent is a crosslinking agent which is formed from a reactant that includes at least one hydroxyalkanoate, such as 3-hydroxyalkanoate. As an example, the crosslinking agent is or includes the reaction product of:

i.) one or more hydroxyalkanoates (e.g., 3-hydroxyalkanoate), such as 3-hydroxyalkanoate ester or 3-hydroxyalkanoate (e.g., 3-hydroxyalkanoate, 3-hydroxyalkanoate oligomer, or 3-hydroxyalkanoate polymer) with

ii.) at least one amine having a single primary or secondary amine functionality and at least two hydroxyl groups having primary or secondary hydroxyl functionality.

The crosslinking agent can be present in an amount of from one part per hundred of the polyol to about 10 parts per hundred of the polyol used in the reaction to form the polyurethane. For purposes of the present invention, it is understood that the crosslinking agent used in the present invention can alternatively or in addition be considered a chain extender.

The hydroxyalkanoate or polyhydroxyalkanoate can have the following formula:

H—(O—CHR¹—CH₂—CO—)ₙOR²

wherein for the hydroxyalkanoate ester, for instance, n=1, R¹═OR, where R is H, methyl, ethyl, propyl, butyl, pentyl, hexyl, octyl, or decyl, and R²=methyl, ethyl, propyl, isopropyl, butyl, isobutyl, pentyl, hexyl, or 2 ethyl hexyl;
wherein for the hydroxyalkanoate oligomer, for instance, n=2 to about 20, R¹═OR, where R² is H, methyl, ethyl, propyl, butyl, pentyl, hexyl, octyl, or decyl;
wherein for the hydroxyalkanoate polymer, for instance, n=21 to about 1000 or more, R¹═OR, where R² is H, methyl, ethyl, propyl, butyl, pentyl, hexyl, octyl, or decyl.

In each case above for the oligomer or polymer, for instance, R²=ester or OH, such as a free acid or alkali/alkaline earth cation, such as sodium, potassium, or calcium.

The hydroxyalkanoate, and in particular, the polymer, may have a crotonate end termination. An exemplary structure is:

(CHR¹═CHCO)(OCHR¹CH₂CO)ₙOR²

wherein R¹, R², and n are as stated earlier in the previous formulas.

The hydroxyalkanoate used as one of the reactants in the reaction to form the crosslinking agent can have any type of steriochemistry. The hydroxyalkanoate can be a racemic hydroxyalkanoate or can be a R-hydroxyalkanoate. The hydroxyalkanoate can be a 3-hydroxyalkanoate, 3-hydroxyalkanoate ester, a 3-hydroxyalkanoate (e.g., a 3-hydroxyalkanoate, 3-hydroxyalkanoate oligomer, or a 3-hydroxyalkanoate polymer), or combinations thereof. The 3-hydroxyalkanoate can be a methyl, ethyl, propyl, isopropyl, butyl, isobutyl, pentyl, hexyl, or 2-ethylhexyl ester of 3-hydroxyalkanoate.

The hydroxyalkanoate can have from 2 to 10,000 repeat units and/or can have a terminal carboxylic acid end group.

With regard to the amine reactant, as stated, the amine includes a single primary or secondary amine functionality. The amine includes at least two hydroxyl groups (e.g., 2, 3, 4, or more) having primary and/or secondary hydroxyl functionality. For purposes of the present invention it is to be understood that the term “at least two hydroxyl groups having a primary or secondary hydroxyl functionality” includes “at least two hydroxyl groups” that have primary hydroxyl functionality, or that have secondary hydroxyl functionality, or that have one or more hydroxyl groups with primary functionality and one or more hydroxyl groups with secondary functionality (e.g., a combination of primary and secondary hydroxyl groups). An example would be a dialkanolamine(s). Examples include a diethanolamine, tris(hydroxymethyl) amino methane, 2 aminoethyl 1,3 propane diol, 2 amino-1-methyl 1,3 propane diol, diisopropanolamine, diisobutanolamine, di-beta-cyclohexanolamine, or any combination thereof. The amount of the reactants (in the reaction to form the crosslinking agent) with regard to the hydroxyalkanoate component and the amine, can be present in equal molar ratios or about equal molar ratios, such as a molar ratio of 0.8:1 to 1:0.8.

The crosslinking agent from this reaction product, if the reaction is fully complete, would, for instance, form a hydroxyalkanoate amide, such as a 3-hydroxyalkanoate amide, for instance, a 3-hydroxybutyrate diethanol amide. Since the reaction can be difficult to go to full completion, the crosslinking agent generally can optionally contain one or more other reaction products, which may include unreacted products, by-products, and the like. The unreacted products, by-products, or both can comprise 50 wt % or less of the reaction product, such as 0 wt % to 50 wt %, 1 wt % to 40 wt %, 3 wt % to 35 wt %, 5 wt % to 30 wt %. For instance, the crosslinking agent can include, as part of the reaction product, alcohol, alkenoic acid, alkenoic diethanol amide, hydroxyalkanoate acid (e.g., 3-hydroxyalkanoate), or any combination thereof. As a further example, the crosslinking agent comprises greater than about 70% by weight of the hydroxyalkanoate amide, such as 3-hydroxybutyrate diethanolamide, and/or from about 1 to about 10 wt % amine, such as diethanolamine, and/or from 0.1 to 5 wt % alcohol, and/or less than 5 wt % alkanoic acid, alkanoic diethanolamide, and/or free hydroxyalkanoate, such as free 3-hydroxyalkanoate. Each of these amounts can vary±5% or±10% or more.

As an example, the crosslinking agent can have the following diethanolamide generic structure:

H(OCHR¹CH₂CO)ₙN(CH₂CH₂OH)₂

where n=1 to 10, such as 1, 2, 3, 4, 5, 6, 7, 8, 9, or 10, and R¹ being as indicated previously. Other crosslinking agents that can be used herein can have similar structures.

In addition to the above reactants to form the polyurethane, additional chain extenders and/or crosslinkers different from the above-mentioned crosslinking agent can be present in crosslinking amounts, such as less than 5% by weight of the total reactants (by weight). One or more catalysts can be present, such as amine compounds or organometallic complexes. One or more surfactants can be present. The catalysts and/or surfactants can be present in conventional amounts.

In making the polyurethanes of the present invention, at least one catalyst is preferably used in the reaction. Conventional catalysts used for the making of polyurethanes can be used in the present invention. For instance, such catalysts include, but are not limited to, tertiary amines, such as triethylamine, dimethylcyclohexylamine, or diazobicyclo[2.2.2.]octane. Conventional amounts of catalysts can be used in the present invention.

One or more blowing agents can be used in the formation of the polyurethanes, if desired. Blowing agents activated chemically or by mechanical means can be used in the present invention. Conventional blowing agents can be used, such as water and/or low-boiling inert liquids, such as hydrocarbons. Preferably, the blowing agent is a pentane, such as a cyclopentane, or can be combinations of various blowing agents. The blowing agent can be used in conventional amounts.

Other additives customary to polyurethane formulations can be used in the present invention including, but not limited to, flame retardants, foam stabilizers, fillers, antioxidants, pigments, and the like. These various additives can be used in conventional amounts, if present. The reaction conditions and various components and amounts that can be present in the present invention are described in a variety of U.S. patents, including, but not limited to, U.S. Pat. Nos. 6,087,466; 6,087,410; 6,043,292; 6,034,149; and 6,087,409, all of which are incorporated in their entirety by reference herein.

In more detail, the polymerization reaction can be catalyzed by tertiary amines, such as dimethylcyclohexylamine, and organometallic compounds, such as dibutyltin dilaurate or bismuth octanoate. Furthermore, catalysts can be chosen based on whether they favor the urethane (gel) reaction, such as 1,4-diazabicyclo[2.2.2]octane (also called DABCO or TEDA), or the urea (blow) reaction, such as bis-(2-dimethylaminoethyl)ether, or specifically drive the isocyanate trimerization reaction, such as potassium octoate.

The catalyst can be amine compounds and/or organometallic complexes. The amine catalysts can be tertiary amines such as triethylenediamine (TEDA, also known as 1,4-diazabicyclo[2.2.2]octane or DABCO, an Air Products's trade mark), dimethylcyclohexylamine (DMCHA), and dimethylethanolamine (DMEA). Specific examples include, but are not limited to, tetramethylbutanediamine (TMBDA), pentamethyldipropylenetriamine, N-(3-dimethylaminopropyl)-N,N-diisopropanolamine, 1,3,5-(tris(3-dimethylamino)propyl)-hexahydro-s-triazine, bis-(2-dimethylaminoethyl)ether (also known as A-99, formerly a Union Carbide product), N-ethylmorpholine, catalysts containing alkyl-substituted nitrogens, such as triethylamine (TEA), 1,8-diazabicyclo[5.4.0]undecene-7 (DBU), and pentamethyldiethylenetriamine (PMDETA), catalysts containing ring-substituted nitrogens, such as benzyldimethylamine (BDMA), catalysts containing a triazine structure, or quaternary ammonium salts, catalysts containing a hydroxyl group or an active amino hydrogen, such as N,N,N′-trimethyl-N′-hydroxyethyl-bis(aminoethyl)ether and N′-(3-(dimethylamino)propyl)-N,N-dimethyl-1,3-propanediamine.

Other examples include organometallic compounds based on mercury, lead, tin (dibutyltin dilaurate), bismuth (bismuth octanoate), and/or zinc. Specific examples include mercury carboxylates, such as phenylmercuric neodeconate, alkyl tin carboxylates, oxides and mercaptides oxides, for example, dibutyltin dilaurate, dioctyltin mercaptide, or dibutyltin oxide, tin mercaptides.

Blowing agents, such as water, certain halocarbons, such as HFC-245fa (1,1,1,3,3-pentafluoropropane) and HFC-134a (1,1,1,2-tetrafluoroethane), and hydrocarbons, such as n-pentane, can be incorporated into the poly side or added as an auxiliary stream.

Surfactants can be used to modify the characteristics of the polymer during the foaming process. They can be used to emulsify the liquid components, regulate cell size, and stabilize the cell structure to prevent collapse and surface defects.

The surfactants can take the form of polydimethylsiloxane-polyoxyalkylene block copolymers, silicone oils, nonylphenol ethoxylates, and/or other organic compounds.

The crosslinking agent of the present invention is generally formed by mixing the hydroxyalkanoate component with the amine at elevated temperatures, such as a temperature of from 90° C. to 100° C. The reaction time for completion is generally from one minute to 50 minutes or more (e.g., 1 hour to 10 hours, 2 hours to 5 hours).

The crosslinking agent, once formed, can then be premixed (in any order) with the at least one polyols, blowing agent, water and catalysts systems prior to be combining with at least one isocyanate using conventional polyurethane manufacturing techniques and processes, such as described in Dow Polyurethanes: Flexible Foams edited by Ron Herrington and Kathy Hock (1997), incorporated in its entirety by reference herein. In general, the method of forming the polyurethane involves taking each of the components and mixing them together at room temperature.

The polyurethane of the present invention surprisingly has one or more beneficial properties compared to the same polyurethane composition, but containing a crosslinking agent without a hydroxyalkanoate component. It was surprising to have a polyurethane with improved properties when such a small change is made to the polyurethane formulation and with regard to the change being the crosslinking agent.

As an example, the polyurethane of the present invention has one or more (e.g., two or more, three or more, four or more, five or more, six or more, seven or more, eight or more, nine or more, ten or more, or all eleven properties) of the following properties. Any combination of these properties can be achieved.

TABLE 1

| ASTM | | | Polyurethane of present |
|---|---|---|---|
| Method | Description | | invention |
| D3574 | Foam Density (kg/m3) | | at least 35, 35-40 |
| D3574- | Constant deflection | | at least 30%, 30%-40% |
| 08D | compression set (wet aging) | | |
| D3574- | Tensile test | Max breaking | at least 95, 95-150, 100-150, 110- |
| 08E | | force (N) | 140, or 130-140 |
| | | Elongation % | at least 14% 14%-25%, 15%-25%, |
| | | | or 20%-25%, |
| D3574- | Tear resistance test (N/m) | | at least 260, 260-450, 275-450, |
| 08F | | | 300-450, 350-450, 400-450 |
| D3574- | Resilience | Rebound | at least 220, 220-325, 240-325, |
| 08H | | height (mm) | 250-325, 275-325, 300-325 |
| | | Rebound % | at least 45, 45-75, 50-75, 55-70, |
| | | | 60-70 |
| D3574- | Dynamic | Initial | at least 6, 6-15, 7-15, 9-15, 7-10 |
| I3 | fatigue | deflection | |
| | (mm) | 80,000 cycles | at least 5, 5-15, 8-15, 9-15 |
| | | 1 hour post | at least 5, 5-15, 8-15, 9-15 |
| | | test | |
| | | % height loss | 10% or less, 8% or less, 5% or |
| | | | less, 3% or less, 2%-5% |

With the present invention, it was determined that acceptable foam densities can be achieved, which are at least comparable to conventional polyurethanes, wherein no hydroxyalkanoate component is used to form the crosslinking agent.

It was also determined that the load-bearing performance can be at least comparable to a polyurethane formed using a crosslinking agent without a hydroxyalkanoate component as one of the reactants.

However, it was also determined that the tear strength, elongation, tensile strength, and/or resiliency were significantly improved compared to a polyurethane formed using a crosslinking agent without a hydroxyalkanoate component as one of the reactants to form the crosslinking agent.

The ability of the polyurethane of the present invention can be improved (based on dynamic fatigue testing) compared to polyurethanes formed using a crosslinking agent without a hydroxyalkanoate component as one of the reactants to form the crosslinking agent.

In making the polyurethanes of the present invention, the reactants can simply be mixed together under ambient conditions with low shear or high shear mixing. The reaction can occur in minutes or in hours depending on temperature and the optional use of catalyst.

The polyurethane can have a number of different properties. The polyurethane can be biodegradable and can be recycled. The polyurethane can be hydrophilic or hydrophobic. Further, the polyurethane can be used in a number of applications, including, but not limited to, coatings, foams (including rigid and flexible), elastomers, dispersions, and other water dispersible applications. The polyurethane can be formed into a number of articles, such as pipes, insulation, and any other articles traditionally formed from polyurethane materials such as dash boards, other automobile components, and the like. These various applications can be accomplished using conventional techniques known to those skilled in the art in view of the present application.

Accordingly, the present invention includes the following aspects/embodiments/features in any order and/or in any combination:

1. The present invention relates to a polyurethane comprising a reaction product of:
(a) at least one isocyanate;
(b) at least one polyol; and
(c) at least one crosslinking agent that is a reaction product of:
   i.) at least one hydroxyalkanoate, such as 3-hydroxyalkanoate ester or 3-hydroxyalkanoate with
   ii.) at least one amine having a single primary or secondary amine functionality and at least two hydroxyl groups having primary or secondary hydroxyl functionality,
wherein said crosslinking agent is present in an amount of from one part per hundred of said polyol to about 10 parts per hundred of said polyol.

2. The polyurethane of any preceding or following embodiment/feature/aspect, wherein said amine is diethanolamine, tris(hydroxymethyl) amino methane, 2-aminoethyl 1,3 propane diol, 2 amino 1-methyl 1,3 propane diol, diisopropanolamine, diisobutanolamine, di-beta-cyclohexanolamine, or any combination thereof.

3. The polyurethane of any preceding or following embodiment/feature/aspect, wherein the 3-hydroxyalkanoate ester is methyl, ethyl, propyl, isopropyl, pentyl, hexyl, or 2-ethylhexyl ester of 3-hydroxyalkanoate.

4. The polyurethane of any preceding or following embodiment/feature/aspect, wherein the 3-hydroxyalkanoate ester is methyl, ethyl, propyl, isopropyl, pentyl, hexyl, or 2-ethylhexyl ester of racemic 3-hydroxyalkanoate.

5. The polyurethane of any preceding or following embodiment/feature/aspect, wherein the 3-hydroxyalkanoate is a racemic 3-hydroxyalkanoate or a racemic 3-hydroxyalkanoate oligomer having from 2 to 10,000 repeat units and a terminal carboxylic acid end group.

6. The polyurethane of any preceding or following embodiment/feature/aspect, wherein the 3-hydroxyalkanoate is a racemic 3-hydroxyalkanoate polymer having from 2 to 10,000 repeat units and a terminal carboxylic acid end group.

7. The polyurethane of any preceding or following embodiment/feature/aspect, wherein the 3-hydroxyalkanoate is a R-3-hydroxyalkanoate or a R-3-hydroxyalkanoate oligomer having from 2 to 10,000 repeat units and a terminal carboxylic acid end group.

8. The polyurethane of any preceding or following embodiment/feature/aspect, wherein the 3-hydroxyalkanoate is a R-3-hydroxyalkanoate polymer having from 2 to 10,000 repeat units and a terminal carboxylic acid end group.

9. The polyurethane of any preceding or following embodiment/feature/aspect, wherein said crosslinking agent comprises greater than about 70% by weight 3-hydroxybutyrate diethanolamide, and/or from about 1 to about 10 wt % diethanolamine, and/or from 0.1 to 5 wt % alcohol, and/or less than 5 wt % alkanoic acid, alkanoic diethanolamide, and/or free 3-hydroxyalkanoate.

10. The polyurethane of any preceding or following embodiment/feature/aspect, wherein the 3-hydroxyalkanoate oligomer is 3-hydroxybutyrate homopolymer or copolymer.

11. The polyurethane of any preceding or following embodiment/feature/aspect, wherein the polyurethane is flexible foam.

12. An article comprising the polyurethane of any preceding or following embodiment/feature/aspect.

13. An article comprising the polyurethane of any preceding or following embodiment/feature/aspect, wherein said article is an automotive seat or part thereof, an aircraft seat or part thereof, bedding, or a furniture foam.

14. The polyurethane of any preceding or following embodiment/feature/aspect, wherein the polyurethane has one or more of the following properties:

| ASTM | | | |
|---|---|---|---|
| Method | Description | | |
| D3574 | Foam Density (kg/m3) | | at least 35, or 35-40 |
| D3574- | Constant deflection | | at least 30%, or 30%-40% |
| 08D | compression set (wet aging) | | |
| D3574- | Tensile test | Max breaking | at least 95, or 95-150, or 100-150, |
| 08E | | force (N) | or 110-140, or 130-140 |
| | | Elongation % | at least 14%, or 14%-25%, or |
| | | | 15%-25%, or 20%-25% |
| D3574- | Tear resistance test (N/m) | | at least 260, or 260-450, or 275- |
| 08F | | | 450, or 300-450, or 350-450, or |
| | | | 400-450 |
| D3574- | Resilience | Rebound | at least 220, or 220-325, or 240- |
| 08H | | height (mm) | 325, or 250-325, or 275-325, or |
| | | | 300-325 |
| | | Rebound % | at least 45, or 45-75, or 50-75, or |
| | | | 55-70, or 60-70 |
| D3574- | Dynamic | Initial | at least 6, or 6-15, or 7-15, or |
| I3 | fatigue | deflection | 9-15, or 7-10 |
| | (mm) | 80,000 cycles | at least 5, or 5-15, or 8-15, or 9-15 |
| | | 1 hour post | at least 5, or 5-15, or8-15, or 9-15 |
| | | test | |
| | | % height loss | 10% or less, or 8% or less, or 5% |
| | | | or less, or 3% or less, or 2%-5% |

15. The polyurethane of any preceding or following embodiment/feature/aspect, wherein the polyurethane is flexible foam.

16. An article comprising the polyurethane of any preceding or following embodiment/feature/aspect.

17. An article comprising the polyurethane of any preceding or following embodiment/feature/aspect, wherein said article is an automotive seat or part thereof, an aircraft seat or part thereof, bedding, or a furniture foam.

18. The polyurethane of any preceding or following embodiment/feature/aspect, wherein one or more of the following properties or sub-properties are improved compared to a polyurethane that is the same except not having said cross-linking agent but having a diethanol amine instead:

| ASTM | | |
|---|---|---|
| Method | Property | |
| D3574 | Foam Density (kg/m3) | |
| D3574- | Constant deflection | |
| 08D | compression set (wet aging) | |
| D3574- | Tensile test | Max breaking |
| 08E | | force (N) |
| | | Elongation % |
| D3574- | Tear resistance test (N/m) | |
| 08F | | |
| D3574- | Resilience | Rebound |
| 08H | | height (mm) |
| | | Rebound % |
| D3574- | Dynamic | Initial |
| I3 | fatigue | deflection |
| | (mm) | 80,000 cycles |
| | | 1 hour post |
| | | test |
| | | % height loss |

19. The polyurethane of any preceding or following embodiment/feature/aspect, wherein the polyurethane is flexible foam.

20. An article comprising the polyurethane of any preceding or following embodiment/feature/aspect.

21. An article comprising the polyurethane any preceding or following embodiment/feature/aspect, wherein said article is an automotive seat or part thereof, an aircraft seat or part thereof, bedding, or a furniture foam.

22. The polyurethane of any preceding or following embodiment/feature/aspect, wherein said polyol is a polymer polyol.

23. The polyurethane of any preceding or following embodiment/feature/aspect, wherein said polyol is a polymer polyol comprising one or more vinyl dispersions.

24. The polyurethane of any preceding or following embodiment/feature/aspect, wherein said polyol comprises SAN, PHD, PIPA, or soybean oil polyol, or any combinations thereof.

25. The polyurethane of any preceding or following embodiment/feature/aspect, wherein said at least two hydroxyl groups have both primary and secondary hydroxyl functionality (e.g., a combination of primary and secondary hydroxyl functionality).

The present invention can include any combination of these various features or embodiments above and/or below as set forth in sentences and/or paragraphs. Any combination of disclosed features herein is considered part of the present invention and no limitation is intended with respect to combinable features.

The present invention will be further clarified by the following examples, which are intended to be purely exemplary of the invention.

### EXAMPLES

### Example 1

High resilient molded foams were produced using reactants that included diethanolamine as the control and used reactants that included a hydroxyalkanoate crosslinking agent (PHA crosslinker). The PHA crosslinker was a reaction product of a 1:1 molar ratio of ethyl 3-hydroxybutyrate and diethanolamine that was reacted together at about 90° C. for 5 hours. Table 2 sets forth the ingredients used to form the polyurethanes in this example.

TABLE 2

| | Control A | Present Invention A |
|---|---|---|
| Formulation components | (pbw) | (pbw) |
| HYPERLITE ® E-848 polyol | 60 | 60 |
| HYPERLITE ® E-849 copolymer polyol | 40 | 40 |
| NIAX ® Y-10184 blowing surfactant | 1 | 1 |
| Diethanolamine crosslinker | 1.2 | 0 |
| PHA Crosslinker example 1 | 0 | 1.48 |
| DABCO ® 33-LV gel catalyst | 0.35 | 0.52 |
| NIAX ® A-1 blowing catalyst | 0.08 | 0.06 |
| Water | 4.2 | 4.2 |
| Toluene diisocyanate index | 100 | 100 |

The above-identified HYPERLITE® resins were from Dow Chemicals. NIAX® and DABCO® products were obtained from Momentive Chemicals. The formulations were prepared by mixing together the components using a mixer and then pouring the mixture into a warm mold set at about 30° C. The resulting foams from each experiment were then measured for properties. The properties were as follows:

Target foam density: 32 kg/m3

Load bearing capability (indentation force deflection, IFD)

Control Sample A:
25% deflection initial load: 146 N/323 mm²
65% deflection initial load: 445 N/323 mm²
25% deflection after further compression to 65% and then recovery to 25%: 110 N/232 mm²
Modulus 3.0

Present Invention:
25% deflection initial load: 182 N/323 mm²
65% deflection initial load: 511 N/323 mm²
25% deflection after further compression to 65% and then recovery to 25%: 134 N/323 mm²
Modulus 2.8

The polyurethane of the present invention showed improved load bearing capability over the diethanolamine control with lower modulus/softer foam. There were noticeable improvements in the following additional properties measured:

Dropping Ball resilience:

Control A-48%

Present Invention A-46%

Both foams have comparable resilience properties.

Compression set properties: 70° C./22 hours 50%:

Control A: 32% immediately after compression and 18% after 30 minutes

Present Invention A: 34% immediately after compression and 20% after 30 minutes

Both formulations have comparable compression set properties.

Tensile strength 7 days after foam production:

Control A: 155 Kpa and 121% elongation @ break

Present Invention A: 169 KPa and 115% elongation @ break

The polyurethane of the present invention showed a noticeable improvement in tensile strength (˜10%) with comparable elongation at break performance (3%).

Tear Strength:

Control A: 243 N/m

Present Invention A: 257 N/m

The polyurethane of the present invention exhibited much improved tear properties over the control.

This demonstrated that in a copolymer foam formulation, the present invention showed noticeable improvements with regard to tensile, tear, and load bearing capabilities.

### Example 2

High resilient molded foams were produced using reactants that included diethanolamine as the control “crosslinker” or used reactants that included a hydroxyalkanoate crosslinking agent (PHA crosslinker), which was prepared as in Example 1. Table 3 sets forth the ingredients used to form the polyurethanes in this example.

TABLE 3

| | | Present |
|---|---|---|
| | Control B | Invention B |
| VORANOL ® 4701 | 100 | 100 |
| Diethanolamine | 1.88 | 0 |
| Water | 3.92 | 4.2 |
| NIAX ® A-1 | 0.08 | 0.08 |
| NIAX ® Y-10184 | 1.2 | 1.5 |
| DABCO ® 33LV | 0.35 | 0.35 |
| PHA crosslinker of | 0 | 4.44 |
| example 1 | | |
| TDI | 54 | 54 |
| Total | 161.43 | 164.57 |

The above-identified base polyol was VORANOL® 4701 from Dow Chemicals. The formulations were prepared by mixing together the components using a mixer and then pouring the mixture into a warm mold set at 30° C. The resulting foams from each experiment were then measured for properties. The properties were as follows:

TABLE 4

| | | | Present |
|---|---|---|---|
| | | Control | Invention |
| Test method | Description | B | B |
| D3574 | Density kg/m3 | 37 | 37 |
| D3574-08D | constant deflection compression set | 36.8 | 33.6 |
| | with wet aging % | | |
| D3574-08E | tensile test | | |
| | maximum breaking force N | 12.9 | 19.5 |
| | elongation % | 90 | 130 |
| D3574-08F | tear resistance test N/m | 246 | 399 |
| | | 287 | 379 |
| | | 224 | 413 |
| D3574-08H | resilience (ball rebound) test % | 43 | 62 |
| | rebound height | 211 | 310 |
| | | 175 | 306 |
| | | 260 | 307 |
| D3574-3 | Dynamic fatigue by constant force | | |
| | pounding | | |
| | Initial deflection 4.5N load mm | 4.9 | 7.3 |
| | Deflection after 80,000 cycles | 8.7 | 9.3 |
| | 4.5N load mm | | |
| | Deflection post 1 hour 4.5N load mm | 8.2 | 8.4 |

As can be seen in Table 4, the tear strength (tear resistance), tensile strength, elongation, and resiliency were each significantly improved, such as 10% or more, 20% or more, 30% or more, 40% or more, in certain tests, compared to the control sample.

### Example 3

Two flexible polyurethane foam slab samples were prepared (a Control with diethanol amine as the crosslinker and a sample with the PHA crosslinker of the present invention) and tested for their dynamic fatigue properties following the ASTM method D3574-I₃. Table 5 shows the formulations used for the samples. Flexible polyurethane foams were produced by mixing 600 g of VORANOL® 4701 polyol (Dow) with 300 g of TDI (Sigma Aldrich) along with the other components listed in Table 5 in a plastic bucket for 6-8 seconds, pouring the mixture into an aluminum mold cavity preheated to 160° F. and then clamping a lid onto the mold. After a 6 minute cure cycle, the flexible polyurethane foam sample of size 300 mm ×600 mm ×100 mm and mass 720 g were removed from the mold. The samples were then vacuum crushed @15 mm Hg for 3 s, 20 mm Hg for 2 s and 25 mm Hg for 3 s. Two complete cycles were carried out prior to testing in order to convert the original closed cell foam into an open cell foam which is typically used for automotive seat applications. Also prior to testing, the foam samples were conditioned for at least 7 days under ISO conditions at 23±2° C. and 50±5% relative humidity.

Test specimens 280 mm ×380 mm ×50 mm were cut from the individual foam slabs ensuring no edge or void defects. Under compression conditions, the foam height at 4.5N load and 40% IFD were measured for each of the samples. Table 6 shows the initial deflection values for the foams under these conditions. After this initial deflection, the samples were then subject to a total of 80,000 deformation cycles where the values from the initial deformation test formed the limits to investigate the fatigue performance.

TABLE 5

| Polyurethane | Control | PHA Crosslinker |
|---|---|---|
| Component | (ppw) | (ppw) |
| VORANOL ® 4701 | 100 | 100 |
| Diethanol amine | 1.88 | 0 |
| Water | 3.92 | 4.2 |
| NIAX ® A1 | 0.08 | 0.08 |
| NIAX ® Y-10184 | 1.20 | 1.5 |
| DABCO ® 33LV | 0.35 | 0.35 |
| PHA Crosslinker from | 0 | 4.44 |
| Example 1 | | |
| TDI (1:1) | 54 | 54 |

TABLE 6

| ASTM | | | | PHA |
|---|---|---|---|---|
| Method | Description | | Control | Crosslinker |
| D3574-I₃ | Dynamic | Initial deflection | 4.9 | 7.3 |
| | Fatigue | 80,000 cycles | 8.7 | 9.3 |
| | (mm) | 1 hour post-test, | | |
| | | 4.5N load | 8.2 | 8.4 |
| | | % height loss | 7.3% | 2.6% |

The ASTM D3574-I₃ Dynamic Fatigue test measures the changes in foam compression properties after 80,000 compression cycles. During this type of testing, most foams traditionally degrade due to mechanical breakdown or collapse of the thin polymer cell walls in the foam and/or by breakdown of the urethane structure. This manifests itself as a loss in height recovery or stiffness of the foam and is a major problem in automotive and airplane seating applications and in furniture and bedding, reducing the longevity of the products.

Table 6 shows that while the PHA Crosslinker sample yielded a high initial zero deflection value indicating a slight softer foam, the loss in height after 80,000 cycles was much less than the Control sample (7.3% for the Control vs. 2.6% for the PHA Crosslinker sample for height loss) initially and an improved recovery after the additional 1 hour post-test cycle. This indicated a significant improvement in both the foam handling and durability properties when the PHA Crosslinker was used compared with the Control standard foam system.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. Polyurethane comprising a reaction product of:
(a) at least one isocyanate;
(b) at least one polyol; and
(c) at least one crosslinking agent that is a reaction product of:
i.) 3-hydroxyalkanoate ester or 3-hydroxyalkanoate with
ii.) at least one amine having a single primary or secondary amine functionality and at least two hydroxyl groups having primary or secondary hydroxyl functionality,
wherein said crosslinking agent is present in an amount of from one part per hundred of said polyol to about 10 parts per hundred of said polyol.

2. The polyurethane of claim 1, wherein said amine is diethanolamine, tris(hydroxymethyl) amino methane, 2-aminoethyl 1,3 propane diol, 2 amino 1-methyl 1,3 propane diol, diisopropanolamine, diisobutanolamine, di-beta-cyclohexanolamine, or any combination thereof.

3. The polyurethane of claim 1, wherein the 3-hydroxyalkanoate ester is methyl, ethyl, propyl, isopropyl, pentyl, hexyl, or 2-ethylhexyl ester of 3-hydroxyalkanoate.

4. The polyurethane of claim 1, wherein the 3-hydroxyalkanoate ester is methyl, ethyl, propyl, isopropyl, pentyl, hexyl, or 2-ethylhexyl ester of racemic 3-hydroxyalkanoate.

5. The polyurethane of claim 1, wherein the 3-hydroxyalkanoate is a racemic 3-hydroxyalkanoate or a racemic 3-hydroxyalkanoate oligomer having from 2 to 10,000 repeat units and a terminal carboxylic acid end group.

6. The polyurethane of claim 1, wherein the 3-hydroxyalkanoate is a racemic 3-hydroxyalkanoate polymer having from 2 to 10,000 repeat units and a terminal carboxylic acid end group.

7. The polyurethane of claim 1, wherein the 3-hydroxyalkanoate is a R-3-hydroxyalkanoate or a R-3-hydroxyalkanoate oligomer having from 2 to 10,000 repeat units and a terminal carboxylic acid end group.

8. The polyurethane of claim 1, wherein the 3-hydroxyalkanoate is a R-3-hydroxyalkanoate polymer having from 2 to 10,000 repeat units and a terminal carboxylic acid end group.

9. The polyurethane of claim 1, wherein said crosslinking agent comprises greater than about 70% by weight 3-hydroxybutyrate diethanolamide, and/or from about 1 to about 10 wt % diethanolamine, and/or from 0.1 to 5 wt % alcohol, and/or less than 5 wt % alkanoic acid, alkanoic diethanolamide, and/or free 3-hydroxyalkanoate.

10. The polyurethane of claim 1, wherein the 3-hydroxyalkanoate oligomer is 3-hydroxybutyrate homopolymer or copolymer.

11. The polyurethane of claim 1, wherein the polyurethane is flexible foam.

12. An article comprising the polyurethane of claim 11.

13. An article comprising the polyurethane of claim 12, wherein said article is an automotive seat or part thereof, an aircraft seat or part thereof, bedding, or a furniture foam.

14. An article comprising the polyurethane of claim 1, wherein said article is an automotive seat or part thereof, an aircraft seat or part thereof, bedding, or a furniture foam.

15. The polyurethane of claim 1, wherein the polyurethane has one or more of the following properties:

| ASTM | | | |
|---|---|---|---|
| Method | Description | | |
| D3574 | Foam Density (kg/m3) | | at least 35, or 35-40 |
| D3574- | Constant deflection | | at least 30%, or 30%-40% |
| 08D | compression set (wet aging) | | |
| D3574- | Tensile test | Max breaking | at least 95, 95-150, 100-150, |
| 08E | | force (N) | 110-140, or 130-140 |
| | | Elongation % | at least 14%, 14%-25%, |
| | | | 15%-25%, or 20%-25% |
| D3574- | Tear resistance test (N/m) | | at least 260, 260-450, 275-450, |
| 08F | | | 300-450, 350-450, or 400-450 |
| D3574- | Resilience | Rebound | at least 220, 220-325, 240-325, |
| 08H | | height (mm) | 250-325, 275-325, or 300-325 |
| | | Rebound % | at least 45, 45-75, 50-75, 55-70, |
| | | | or 60-70 |
| D3574- | Dynamic | Initial | at least 6, 6-15, 7-15, 9-15, or |
| I3 | fatigue | deflection | 7-10 |
| | (mm) | 80,000 cycles | at least 5, 5-15, 8-15, or 9-15 |
| | | 1 hour post | at least 5, 5-15, 8-15, or 9-15 |
| | | test | |
| | | % height loss | 10% or less, 8% or less, 5% or |
| | | | less, 3% or less, 2%-5% |

16. The polyurethane of claim 15, wherein the polyurethane is flexible foam.

17. An article comprising the polyurethane of claim 16.

18. An article comprising the polyurethane of claim 15, wherein said article is an automotive seat or part thereof, an aircraft seat or part thereof, bedding, or a furniture foam.

19. The polyurethane of claim 1, wherein one or more of the following properties or sub-properties are improved compared to a polyurethane that is the same except not having said cross-linking agent but having a diethanol amine instead:

| ASTM | | |
|---|---|---|
| Method | Property | |
| D3574 | Foam Density (kg/m3) | |
| D3574- | Constant deflection | |
| 08D | compression set (wet aging) | |
| D3574- | Tensile test | Max breaking |
| 08E | | force (N) |
| | | Elongation % |
| D3574- | Tear resistance test (N/m) | |
| 08F | | |
| D3574- | Resilience | Rebound |
| 08H | | height (mm) |
| | | Rebound % |
| D3574- | Dynamic | Initial |
| I3 | fatigue | deflection |
| | (mm) | 80,000 cycles |
| | | 1 hour post |
| | | test |
| | | % height loss |

20. The polyurethane of claim 19, wherein the polyurethane is flexible foam.

21. An article comprising the polyurethane of claim 20.

22. An article comprising the polyurethane of claim 21, wherein said article is an automotive seat or part thereof, an aircraft seat or part thereof, bedding, or a furniture foam.

23. The polyurethane of claim 1, wherein said polyol is a polymer polyol.

24. The polyurethane of claim 1, wherein said polyol is a polymer polyol comprising one or more vinyl dispersions.

25. The polyurethane of claim 1, wherein said polyol comprises SAN, PHD, PIPA, or soybean oil polyol, or any combinations thereof.

26. The polyurethane of claim 1, wherein said at least two hydroxyl groups have both primary and secondary hydroxyl functionality.
